(19) United States
(12) Patent Application Publication
(10) Pub. No.: US 2011/0006515 A1
(43) Pub. Date: Jan. 13, 2011

(54) FLARE-THROUGH HOSE FITTINGS, HOSE ASSEMBLY, AND METHOD OF MANUFACTURING

(75) Inventors: David Yanik, Marion, NC (US); Bruce Graning, Marion, NC (US)

Correspondence Address: FITZPATRICK CELLA HARPER & SCINTO, 1290 Avenue of the Americas, NEW YORK, NY, 10104-3800, US

(73) Assignee: CRANE CHEMPHARMA RESISTOFLEX, Marion, NC (US)

(21) Appl. No.: 12/832,691

(22) Filed: Jul. 8, 2010

Related U.S. Application Data
(60) Provisional application No. 61/223,957, filed on Jul. 8, 2009.

(51) Int. Cl. F16L 11/00; F16L 47/00

(52) U.S. Cl. 285/239; 138/137; 138/109

(57) ABSTRACT

A method of making a hose is provided that includes providing a fitting configured to receive a hose liner therethrough and configured to receive a material configured to be bonded to the hose liner. The method includes receiving the material in the fitting, drawing the hose liner through the fitting, and bonding the material to the hose liner such that the hose liner and material are secured to an outer face of the fitting.

### CROSS REFERENCE TO RELATED APPLICATIONS

This application claims the benefit of priority under 35 U.S.C. §119(e) to U.S. Provisional Application No. 61/223,957, filed on Jul. 8, 2009, the entire contents of which are incorporated by reference herein.

### BACKGROUND

### Field

The present disclosure relates to an arrangement of a hose liner and hose fitting which can reduce the potential for contamination between the hose liner and the hose fitting. More particularly, one aspect is related to an arrangement of an interface between a fluoropolymer lined hose and a sealing flange of a hose fitting which reduces the potential for entry of contamination therebetween.

Within industries concerned with conveying chemical and pharmaceutical media under conditions of very high purity hose and piping end fitting connections are commonly arranged in accordance with the American Society of Mechanical Engineers Bio-Pharmaceutical Equipment (ASME BPE 2009) standard, which is incorporated by reference herein in its entirety. These fitting designs are generally robust and trouble-free for users. For example, one commonly used type of hose fitting is a “sanitary flange fitting” 101 shown in the section view in FIG. 1. The hose fitting 101 is attached to the end of the hose 102 which is comprised of a liner 104 in a carcass 106. However, within the specific arena of hoses, the hose-to-end fitting connection has been identified as a potential source of media entrapment. As pointed out in FIG. 1, an area between the inner end 103 of the fitting 101 and a liner 104 is a potential area for the accumulation of contamination, such as in the form of diluents and bacterial blooms. The areas of accumulation are largely the result of elevation changes at the hose liner/fitting interface, and a microscopic gap that can exist between the hose liner and the outer surface of the fitting near its inner end 103.

Sanitary fittings configured in accordance with ASME BPE 2009 also include a concave annular groove 107 formed in the face 105, which facilitates alignment of a sanitary sealing gasket having a mating convex annular surface. Such a gasket is disposed between two mating sanitary fittings 101 and held in position by the application of compressive forces from the sanitary fittings using a clamp, as is known in the art.

In response to the problem of contamination accumulation between the inner end 103 and the liner 104, hoses with flared-through liner were developed, an example of which is shown in FIG. 2. The flared-through hose and fitting designs can mitigate the problem of entrapment of contaminants at the area identified in FIG. 1 by extending a hose liner 204 through an end fitting 201, eliminating the discontinuity at the hose liner 204/fitting 201 interface, and subsequently expanding (“flaring”) an exposed outer end of the liner 204 radially outward onto the flanged face 205 of the fitting 201, forming a sealing surface 208 over the face 205. Upon flaring the hose liner 204, a sealing gasket groove 207, is then imparted to the sealing surface 208 of the liner 204 conforming to a concave groove 206 formed in the face 205 of the fitting 201, such that the sealing surface 208 and the sealing gasket groove 207 can receive sanitary gaskets.

While flare-through hose liner 204 and fitting 201 designs are considered a solution to the foregoing problem of entrapment of contamination in conventional sanitary hose assemblies, contamination problems remain with flare-through designs. Specifically, the sealing surface 208 tends to warp in a wavy pattern, allowing contaminants to be introduced between gaps formed between an inner side of the sealing surface 208 and the flanged face 205 of the fitting 201. Although this area is not part of the normal fluid stream, it is known to be resistant to normal cleaning methods, and subsequent bacterial migration or leaching can contaminate the fluid stream. The existing flare-through designs (e.g., FIG. 2) rely on one of two solutions to ensure that the flared sealing surface 208 remains flat and in intimate contact with the metallic substrate 205 of the fitting 201, especially against the face of the fitting. One solution to this problem is to use liner materials that possess an inherent moldability, which enables the flare, when formed under proper conditions of time, temperature, and pressure, to remain relatively flat and stable during normal handling, installation and cleaning operations. A second solution to this problem is to use an adhesive to bond the flared sealing surface 208 to the face 205 of the fitting 201.

However, both of these conventional solutions have drawbacks. First, designs which rely on the moldability and stability of the plastic liner to achieve a flat flare surface still suffer from the problem of contaminants entering behind the flare 208 due to wicking. The flare-through hose can suffer from wicking (i.e., capillary) action of liquid that causes the liquid to migrate into and remain in any small clearances between the flared liner 208 and the face 205 of the fitting 201.

Moreover, designs which rely on adhesive(s) to bond the flared sealing surface 208 to the face 205 are also problematic. The commonly used liner 204 materials are a class of plastics known as fluoroplastics. The very qualities which make these materials desirable for high purity applications, including chemical resistance and low affinity for liquid media, make them very difficult to bond with traditional adhesives. Accordingly, the surface of these plastics must be etched or otherwise treated by one of several techniques to form a surface which can be bonded with adhesives. A problem with etching or treating the liner is that neither the etched surface, nor the adhesive are safe for environments requiring high purity. Firstly, the adhesives are toxic chemicals. Secondly, the etching or treatment process works by stripping sub-atomic particles and otherwise modifying the plastic on a molecular level, effectively creating a surface of unknown chemical make-up. As the etching and adhesive are not in the fluid stream, the design can be functional, but the presence of these materials adds a level of risk to the hose design. In the event of a breach of the liner 204, a potentially highly toxic substance can be introduced to the process media.

### SUMMARY

Accordingly, solutions are set forth below for the problems associated with flared through hoses discussed above.

In a first aspect a method of making a hose is provided that includes providing a fitting configured to receive a hose liner therethrough and configured to receive a material configured to be bonded to the hose liner. The method includes receiving the material in the fitting, drawing the hose liner through the fitting, and bonding the material to the hose liner such that the hose liner and material are secured to an outer face of the fitting.

In another aspect, a hose is provided that includes a hose liner, a retaining member extending from the hose liner, at least one fitting having an outer sealing face. The fitting is configured to receive the hose liner therethrough and is also configured to engage at least a portion of the retaining member to retain at least a portion of the hose liner against the sealing face of the fitting.

In yet another aspect, a fitting for a hose is provided. The fitting includes a body portion configured to received a hose liner therethrough, and a flanged portion extending from the body portion including an outwardly directed sealing flange. The flanged portion is configured to receive a hose liner therethrough. The sealing flange is configured to receive a portion of the hose liner and is configured to receive and retain at least a portion of a retaining member when the retaining member is in a melt-processable state and when the retaining member is in a bonded state when bonded to the portion of the hose liner.

Also, in another aspect a hose produced according to a method is provided. The method includes providing a fitting configured to receive a hose liner therethrough and configured to receive a material configured to be bonded to the hose liner. The method includes receiving the material in the fitting, drawing the hose liner through the fitting, and bonding the material to the hose liner such that the hose liner and material are secured to an outer face of the fitting.

### BRIEF DESCRIPTION OF THE DRAWINGS

The attached drawing figures provide additional disclosure:

FIG. 1 shows a sectional view of a hose assembly that does not employ a flare-through arrangement.

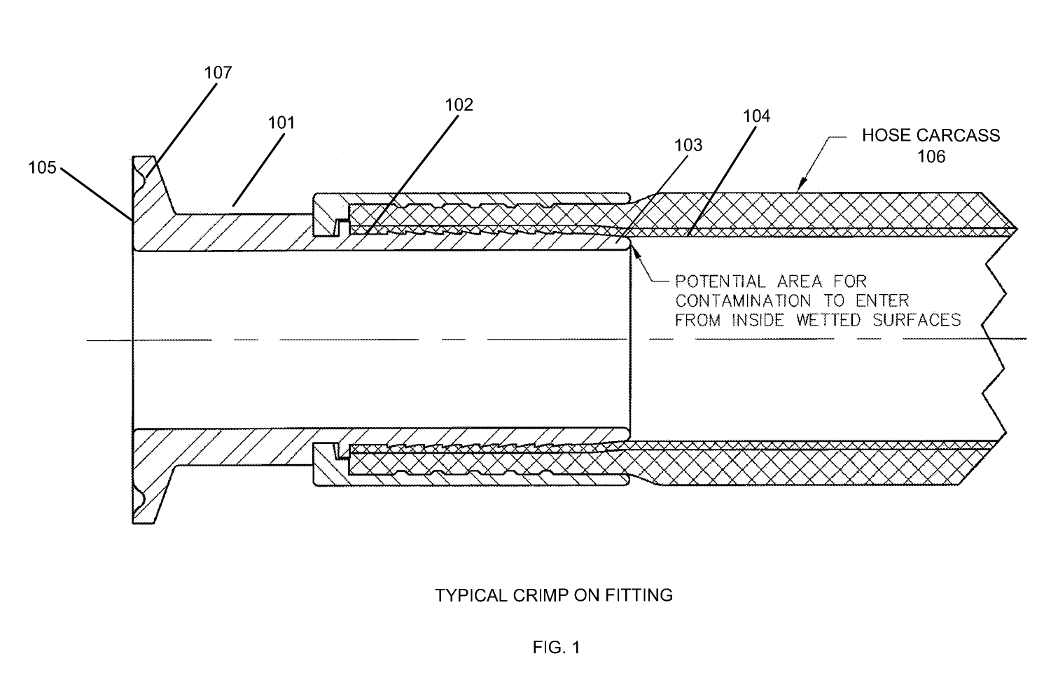

FIG. 2 shows a sectional view of a flare-through hose assembly.

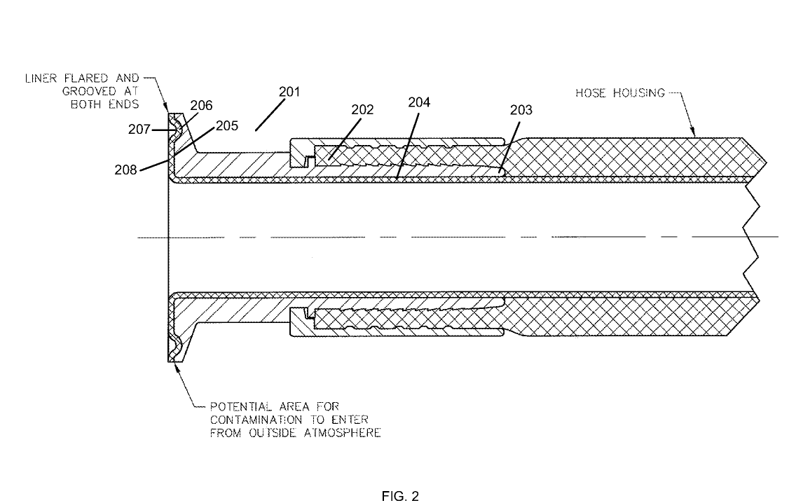

FIG. 3A shows various details of an exemplary embodiment. This figure should be read as being to scale, and the proportions shown therein constitute part of the disclosure.

FIG. 3B shows an exploded sectional view of a portion of the end fitting shown in FIG. 3A.

FIG. 3C shows another exemplary embodiment of an end fitting.

FIG. 4 shows an exploded sectional view of a portion of a hose in accordance with an embodiment.

FIG. 5 shows an exploded cutaway view of a portion of another embodiment of an end fitting.

FIG. 6 shows an exploded cutaway view of a portion of another embodiment of an end fitting.

FIG. 7 shows an embodiment of a grooving tool used in conjunction with another embodiment of an end fitting.

FIG. 8 shows an embodiment of a forming head.

FIG. 9 shows an embodiment of a grooving tool used in conjunction with another embodiment of an end fitting.

### DETAILED DESCRIPTION

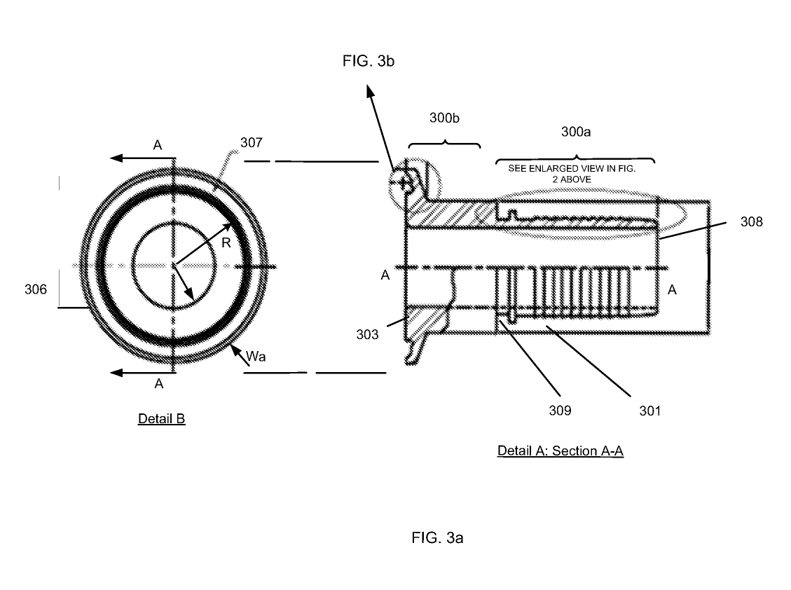

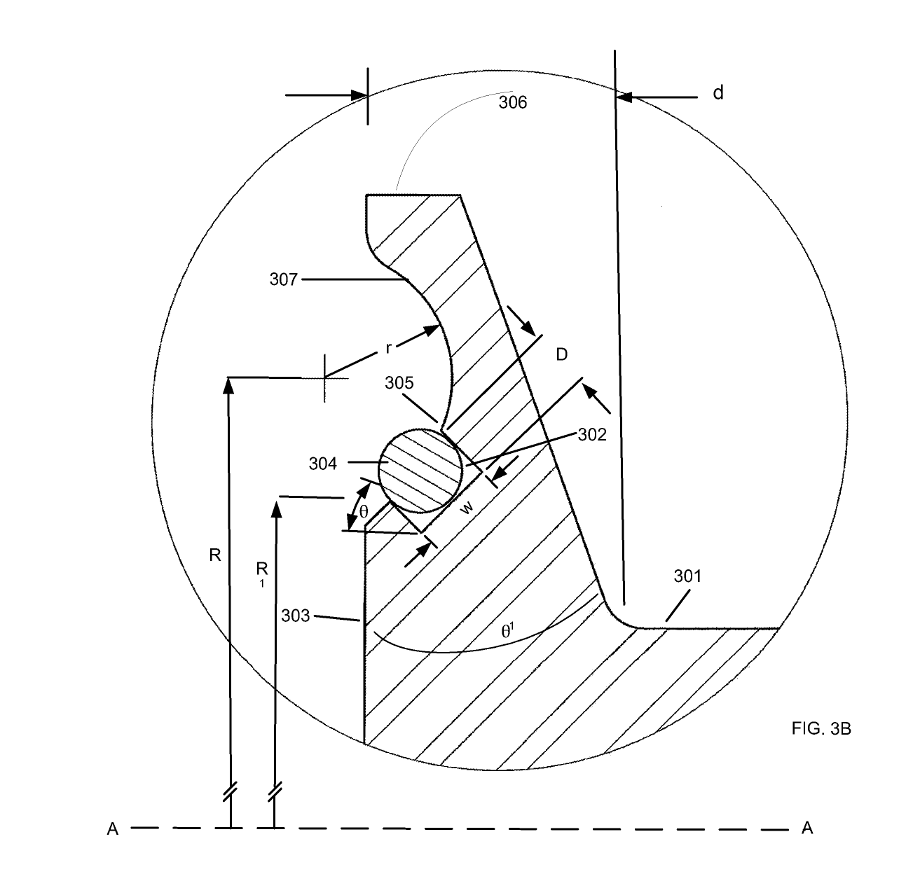

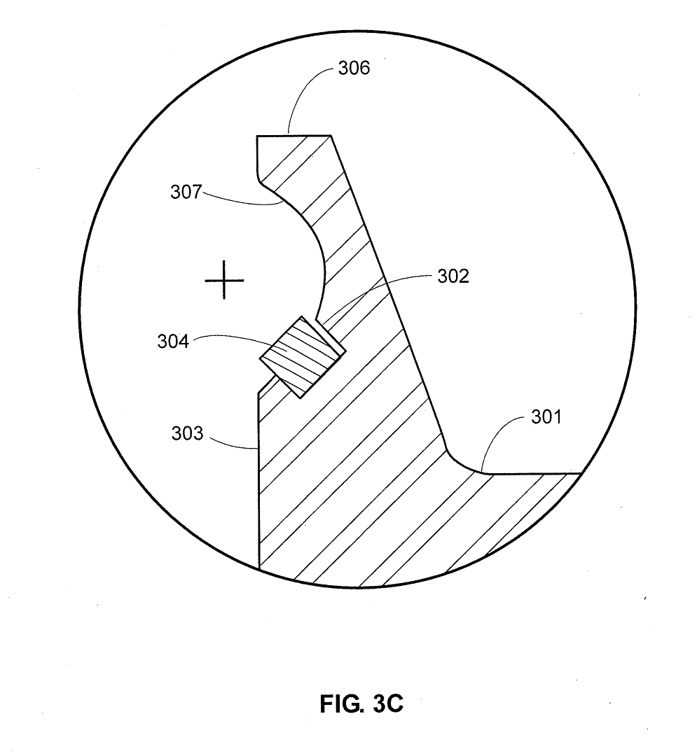

FIG. 3A shows, in detail A, a section view of an embodiment of an end fitting 301. The fitting 301 includes a body portion 300a formed generally as a hollow cylinder having a serrated or barbed outer surface extending from a first, open end 308 toward a second end 309 in communication with a flanged portion 300b. The flanged portion 300b extends from the second end 309 toward an open, flanged face 303 of a sealing flange 306. As shown in detail A, the body portion 300a and the flanged portion 300b are coaxial with respect to a longitudinal axis A-A through the center of portion 300a and 300b, and are configured to be coaxial with a hose (not shown) in which the body portion 300a is configured to be inserted.

As shown in detail B, the face 303 of the end fitting 301 includes a concave sealing gasket groove 307 formed therein. FIG. 3B shows an enlarged partial section view of the flange 306 shown in details A and B, including detail of the groove 307. The groove 307 is generally hemispherical having a radius r centered at a radius R with respect to the axis A-A. In one embodiment where the end fitting 301 has a nominal diameter of 1 inch, the radius r is about 0.092 inches and the radius R is about 1.718 inches.

Groove 302 is formed in groove 307. The groove 302 is shown having a lower edge at the surface of groove 307 that is a predetermined radial distance R¹ from axis A-A. In one embodiment where the end fitting 301 has a nominal diameter of 1 inch, the radius R¹ is about 1.538 inches. The groove 302 is configured to retain a ring 304 of melt-processable material therein. In at least one embodiment, the end fitting 301 can be formed from a metal, such as stainless steel, and the grooves 307 and 302 may be formed in the face 303, such as by machining, casting, and the like. Of course, in other embodiments, other materials may be used to form the end fitting 301. Moreover, while the groove 302 is shown in FIG. 3B as being formed in groove 307, in other embodiments, the groove 302 may be formed in another portion of the face 303 which, for example, can accommodate the groove 302.

The groove 302 is shown formed having a generally square or rectangular shape extending in a direction at a predetermined angle θ with respect to axis A-A. The groove 302 is formed having a predetermined width w and depth D. The dimensions of the groove 302 are configured to retain the ring 304 therein, such as by friction or compression fit, such that the ring 304 will not tend to fall out of the groove 302 prior to or during processing of the fitting 301 and hose, described herein. For example, in one embodiment, the ring 304 is constructed so that the inner radius of the ring 304 is less than the dimension R1 of the fitting 301. Once stretched beyond the edge of the groove 304 at dimension R1, the ring 304 can be inserted into the groove 302. The resiliency of the ring 304 will tend to keep the ring 304 in the groove 302 and, therefore, the ring 304 will not tend to fall out of the groove 302 prior to or during processing of the fitting 301 and hose, described earlier.

The angle θ of the groove 302 with respect to axis A-A can be an acute angle and is preferably between 30 and 45 degrees. In one embodiment, the groove 302 is configured to at least partially receive an o-ring 304 having a predetermined cross-sectional diameter which can vary, for example, between 0.035 and 0.060 inches, depending on the nominal size and configuration of the end fitting 301. In one embodiment where the end fitting 301 has a nominal diameter of 1 inch, the o-ring has an annular diameter of 1.5 inches and has a cross-sectional diameter of about 0.060 inches. The inside radius of the ring 304 is made smaller than the dimension R1 of the fitting 301. Once snapped into groove, the ring 304 will not tend to fall out of the groove 302 prior to or during processing of the fitting 301 and hose, described earlier.

The annular width Wₐ (FIG. 3B), the depth of the flange 306 (FIG. 3C), and the configuration and placement of the groove 307 may vary based on the nominal diameter size of the end fitting 301. For example, a nominal 1 inch diameter sanitary fitting has a larger annular width Wₐ than a nominal 2 inch sanitary fitting and, therefore, additional surface area to accommodate the groove 302. Accordingly, for the various sized sanitary fittings, the dimensions and location of the groove 302 (and therefore the ring 304), are configured based at least upon the nominal size of the sanitary fitting 301.

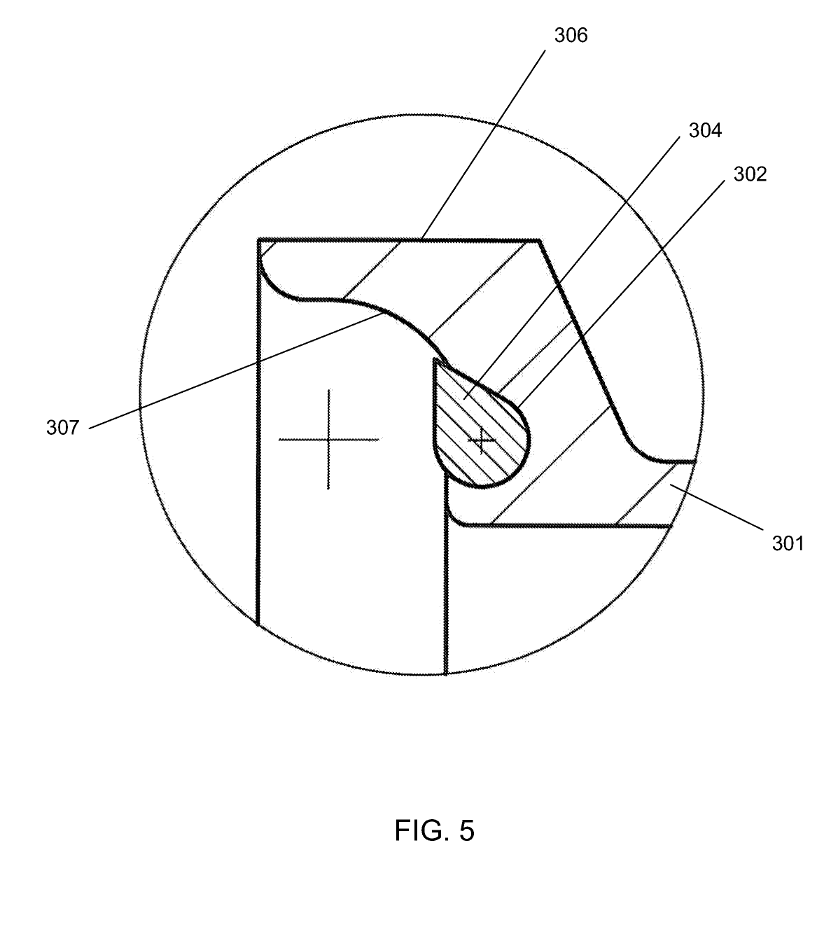

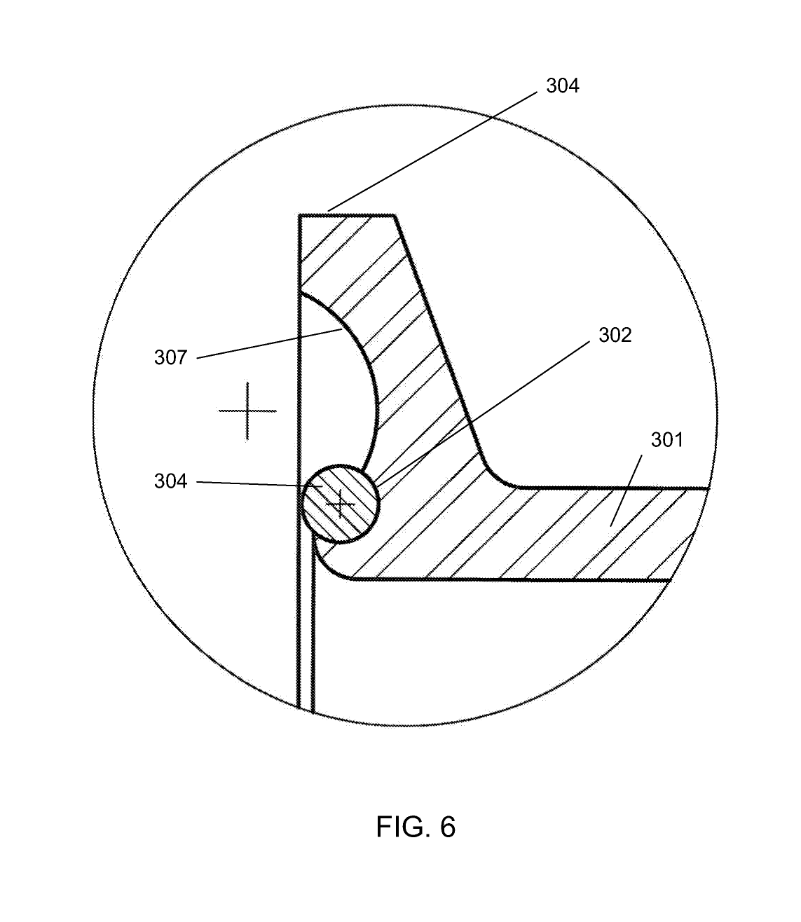

In the case of sanitary fittings constructed in compliance with ASME BPE 2009, the shapes of the groove 302, as well as their location on the face 303, may be selected based upon the nominal inner diameter of the hose assembly, and the arrangement of standard sized sanitary style fittings corresponding to the nominal inner hose diameter. For example, arrangement of the groove 302 shown in FIGS. 3A-3C can be used for a hose assembly having nominal inner diameter of 1 inch by forming the groove 302 into a standard 1 inch sanitary fitting. Moreover, the arrangement shown in FIG. 5 can be used for a nominal inner diameter of ¾ inch by forming the groove 302 into a standard ¾ inch sanitary fitting. The arrangement shown in FIG. 6 can be used for a nominal inner diameter of 1½ inches and 2 inches by forming the groove 302 into a standard 1 ½ inch and 2 inch sanitary fitting.

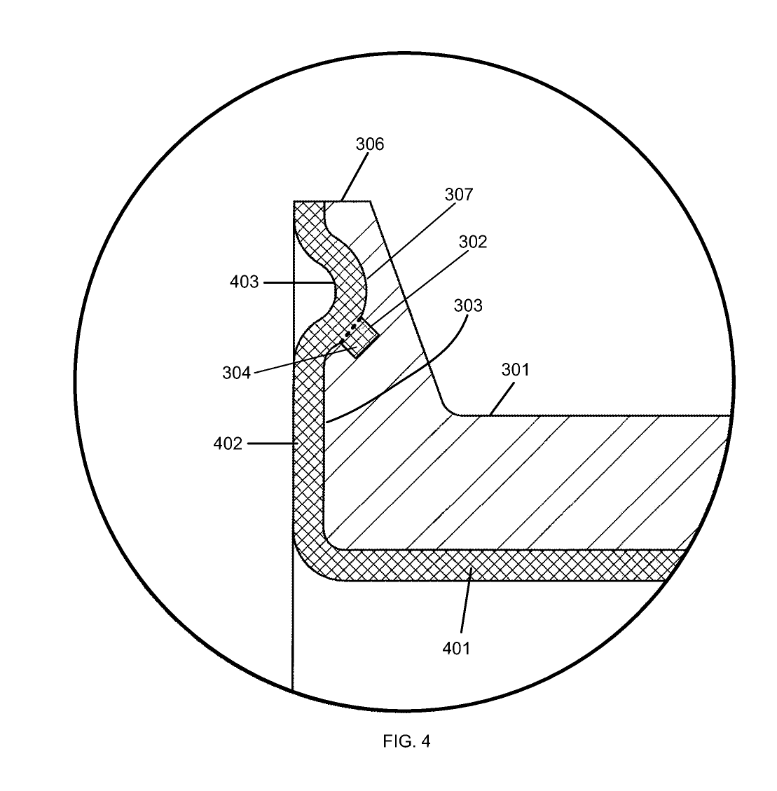

As shown in FIG. 3B, the groove 302 is configured to receive the aforementioned ring 304, which, in at least one exemplary embodiment, is a pre-formed melt-processable material, and more preferably, a material which, when heated to a predetermined temperature, will flow in the groove 302 and contact another material that is disposed in groove 307, such as a portion of a hose liner 401 (FIG. 4) that is flared over the face 303 of the end fitting 301. Accordingly, in at least one embodiment, the groove 302 acts as a mold in forming a net-shape of the ring 304, upon processing.

In one embodiment, the ring 304 is formed of a material which can be molded to the shape of the groove 302 while also being bonded to a material used for the hose liner 401 (FIG. 4). In one embodiment the hose liner 401 is formed from polytetrafluoroethylene (PTFE), and the ring 304 can be formed from at least one of perfluoroalkoxy (PFA) and tetrafluorethylene-perfluorpropylene (FEP). The melting point at atmospheric pressure of PTFE is about 621 degrees Fahrenheit while the melting point of PFA is about 582 degrees Fahrenheit and the melting point of FEP is about 500 degrees Fahrenheit.

As shown in FIG. 4, the face 303 of the fitting 301 is configured to be covered by a flared sealing surface 402 of the liner 401. The flared liner sealing surface 402 is processed such that a portion of the liner 401 covering the groove 307 will be pressed into the groove 307 and will come into contact with the melt-processable ring 304 and become bonded to the liner 401 during a forming process which applies heat and pressure to the liner against the fitting 301. By virtue of the angle θ (FIG. 3B) of the groove 302, and the combined structure composed of the molded ring 304 and the sealing surface 402 of the liner 401, becomes interlocked with the face 303 of the end fitting 301. The molded ring 304 forms a lip around the opening in the end fitting 301 at a radius R1 (FIG. 3B). This lip interlocks the sealing surface 402 with the sealing face 303 and can prevent warping of the sealing surface 402 away from the sealing face 303. Moreover, because the molded ring 304 forms a lip that extends beneath the sealing face 303, the lip can act as a barrier to limit the migration of contaminants radially inwardly at the interface between the sealing face 303 and the liner 401.

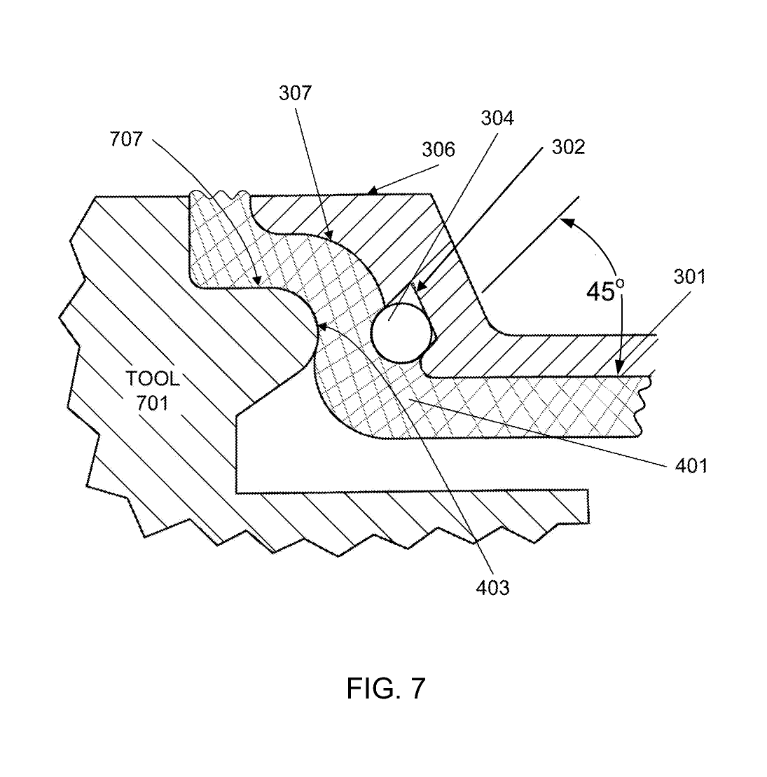

In other alternative embodiments the groove 302 may also have a curved shape, including teardrop (FIG. 5) and hemispherical shapes (FIG. 6), as well as other rectilinear shapes including but not limited to, T-shape, trapezoidal, triangular, square, rectangular, and dovetail (FIG. 7) shapes. In an alternate embodiment shown in FIG. 3C, the o-ring 304 shown in FIG. 3B is replaced with a ring having a generally square cross section, which is seated in groove 302 having a generally square cross section.

Another embodiment of an end fitting 301 is shown in FIG. 5. The end fitting 301 is constructed to receive a ring 304 having a teardrop shaped cross section. The fitting 301 has a corresponding teardrop shaped groove 302. At least a portion of the teardrop shaped cross section of the ring 304 conforms to the surface of the teardrop shaped groove 302. In its unprocessed state, the teardrop shaped ring 304 is seated and positioned in the groove 302 such that the outer exposed surface of the ring 304 substantially conforms to the curvature of the groove 307. In one embodiment, the teardrop shaped groove 302 and ring 304 are formed in a modified ¾ inch standard sanitary fitting so that the resulting fitting can be used to connect to ¾ inch standard sanitary fittings and gaskets.

Also, as shown in FIG. 6, another embodiment of an end fitting 301 is shown that is constructed to receive a ring 304 having a circular shaped cross section. Such circular shaped ring 304 can be of similar construction to the o-ring described with respect to FIGS. 3A-3C. The fitting 301 has a corresponding curved groove 302, which is shown as being generally semicircular and conforms to the surface of the ring 304. In one embodiment, the circular groove 302 and ring 304 are formed in a modified ¾ inch standard sanitary fitting so that the resulting fitting can be used to connect to ¾ inch standard sanitary fittings and gaskets.

As shown in FIG. 7, another embodiment of an end fitting 301 is shown that is constructed to receive a ring 304 having a circular shaped cross section. In FIG. 7, the groove 302 has a dovetail shape. That is, the two sides of the groove 302 extend at an acute angle with respect to the base of the groove 302 so that the outer edges of the groove 302 at the surface of groove 307 pinch and retain the unprocessed ring 304, at least partially, in the groove 302. In one embodiment, the dovetail shaped groove 302 and circular ring 304 are formed in a modified ¾ inch standard sanitary fitting so that the resulting fitting can be used to connect to ¾ inch standard sanitary fittings and gaskets.

A method of manufacturing a lined hose will now be described. In one embodiment of the method, an end fitting 301, constructed in accordance with the first aspect, is provided and a hose liner 401 is drawn through the end fitting 301. In one embodiment, the hose liner 401 is drawn concurrently through a hose carcass (not shown) and the end fitting 301. The method also includes introducing the melt-processable ring 304 into the groove 302. The hose liner 401 is drawn through the end fitting 301 outwardly from the face 303 a certain distance sufficient to flare the drawn end of the liner 401 over the face 303 of the end fitting 301. The drawn end of the liner 401 is heated to a gel state and is flared radially outwardly onto the face 303, preferably using a hydraulic operated balloon which inflates from within the end of the hose liner 401 to spread the liner 401 toward the sealing face 303 of the end fitting 301.

While the sealing face 303 is in the gel state, a grooving tool 701 (FIG. 7), shown in one embodiment in FIG. 7, is pressed onto the flared liner 401 at a predetermined pressure sufficient to press the flared liner 401 into the groove 307 and impart a sealing gasket groove 403 (FIGS. 4, 7, and 9) which is configured to receive a complimentary surface of a sanitary gasket (not shown). The grooving tool includes a protruding surface 707 which, when aligned with the sealing surface 402, imparts the formed sealing gasket groove 403 into the sealing surface 402. Moreover, the grooving tool compresses the liner 401 into contact with and around a portion of the ring 304 that protrudes from the groove 302 above the surface of groove 307.

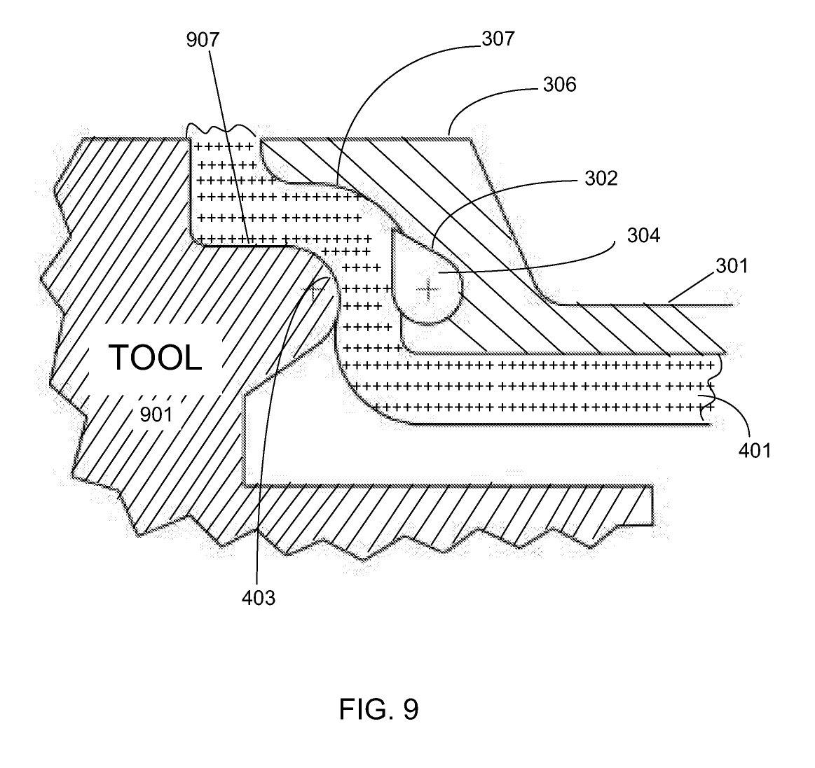

FIG. 9 shows a similar arrangement of the grooving tool and end fitting shown in FIG. 7, except that the fitting 301 and ring 304 are shown corresponding to the embodiment shown in FIG. 5, described above. Also shown in FIG. 9 is a grooving tool 901 which has a protruding surface 907 which is similar in shape to the protruding surface 707 shown in FIG. 7. The forming tool 901 is used in the same manner as forming tool 707 to form sealing gasket groove 403.

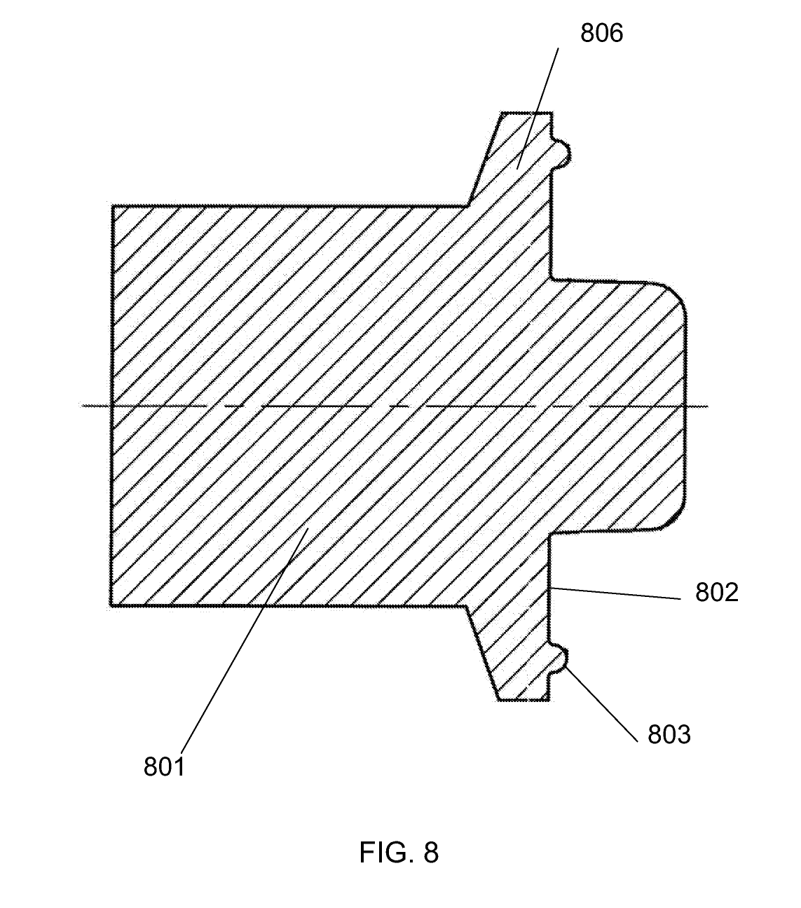

A forming head 801, an example of which is shown in FIG. 8, is pressed onto the sealing surface face 402 of the end fitting 301, and is pressed in contact to apply a predetermined pressure to the sealing surface face 402 especially in the area of the grooves 403, 302, and 307. In one embodiment, the forming head 801 can be retained against the sealing surface 402 with a sanitary clamp (not shown). Such a sanitary clamp can compress a flange 806 of the forming head 801 against the sealing flange 306 of the end fitting 301. Preferably, the forming head 801 has a sealing face 802 that is configured to engage and align with the grooved flared face 402 in a similar fashion to a sanitary gasket. For example, as shown in FIG. 8, a forming head is shown in section view showing an annular raised hemispherical ridge 803 extending from the face 802 configured to engage and seal with the mating sealing gasket groove 403 and sealing surface 402.

While retained against the surface 402, forming head 801 and at least a portion of the end fitting 301 are inserted into a salt bath that is maintained at a predetermined temperature for a predetermined duration up to a depth covering the sanitary clamp holding the forming head 801 to the end fitting 301. In an exemplary embodiment, where a flared 1 inch stainless steel end fitting 301 is configured as shown in FIGS. 3A-3C, is attached to a 1 inch forming head 801, and the hose liner is made from PTFE and the ring is made from PFA, the temperature of the salt bath is preferably about 720 degrees Fahrenheit and the forming head 801 and the end fitting 301 are inserted in the salt bath for about 4 minutes.

While still compressed together, the end fitting 301 and the forming head 801 of the hose assembly are inserted into a cooling bath, comprised of, for example, water, to a predetermined depth, measured inwardly from the sealing surface 402, for a predetermined amount of time. At the end of that predetermined amount of time, the end fitting 301 and forming head 801 are immersed to a greater depth in the cooling bath, such as down to the second end 309 (FIG. 3A) of the body portion 300a of the end fitting 301, for another predetermined duration to rapidly cool the end fitting 301. For example, in the exemplary embodiment discussed above for the 1 inch sanitary fitting in accordance with FIGS. 3A-3C, the end fitting 301 is inserted in the cooling bath to a depth of about ½ inch inward of the sealing surface 402 for 1 minute prior to fully immersing the remainder of the flanged portion 300b of the fitting 301 in the cooling bath. Upon cooling of the sealing surface 402 and the ring 304 to a certain temperature, the forming head 801 can be released from the sealing face 303.

In one embodiment, the forming head 801 can be configured with a thermal mass at a longitudinally outward end of the forming head 801 which is sufficient to act as a heat sink that can keep the longitudinally inner portions of hose liner 401, which are surrounded by the body portion 300a of the end fitting 301, from being heated above a certain temperature, while concentrating the heat transferred from the salt bath at the sealing surface 402 and the sealing flange 306, in order to melt the ring 304 and the flared liner 402 and bond the them together, as shown in FIG. 4. In at least one embodiment, by virtue of heat transfer to the sealing surface 402 from the forming head 801, the ring 304 and flared liner 402 are heated at least to the higher of the melting points of the ring 304 and the liner 401 while the sealing surface 402 is compressed onto the face 303 and in the groove 307 at a predetermined pressure. In cooling the end fittings 301, the temperature of the sealing surface 402 and the ring 304 are decreased below a predetermined temperature to a state where the ring 304 is sufficiently solidified in the shape of the groove 302 and is strong enough to hold a formed shape of the groove 302 prior to removing the restraining pressure holding the forming head 801 against the sealing surface 402.

A comparison was made between two different hose/end fitting connections using a nominal 1 inch diameter hose of a type available under the trademark Stratus from Crane Co. (smooth PTFE inner core, and platinum-cured silicone with stainless-steel wire and fabric reinforcement) after soaking each end fitting connection for 15 seconds in dye penetrant (Kingscote fluorescent red tracer dye item #106023 FWT 25). One end fitting 301 was configured in accordance with an embodiment described above using a dual-grooved fitting 301, the PTFE liner bonded to a melt-processable PFA o-ring molded in the groove 302 of the fitting 301. A second end fitting did not include a PFA O-ring at all. The end fitting face 303/sealing surface 402 interface at the first end fitting showed a flatter sealing surface 402 than compared to the second end fitting. In the latter instance, the flared face which did not have a PFA o-ring bonded thereto consequently displayed a characteristic wavy appearance and separation from the sealing face 303 of the end fitting 301. In the case of the first tested configuration, it was found that in between the sealing surface 402 and the face 303 penetrant did not move moved radially inward past the PFA o-ring. In the case of the second configuration without the ring 304 bonded to the sealing flange 402, it was found that in between the sealing surface 402 and the face 303 penetrant was detected radially inwardly past the radial distance of the ring 302 in the first configuration. In this latter case, close clearances between the sealing surface 402 and the face 303 captured and restrained the penetrant from draining when the flared end fitting was removed from the soaking solution.

While the present invention has been described with respect to various embodiments, it is to be understood that the invention is not limited to the disclosed embodiments. To the contrary, the invention is intended to cover various modifications and equivalent arrangements included within the spirit and scope of the appended claims.

What is claimed is:

1. A method of making a hose comprising the steps of:
providing a fitting configured to receive a hose liner therethrough and configured to receive a material configured to be bonded to the hose liner;
receiving the material in the fitting;
drawing the hose liner through the fitting; and
bonding the material to the hose liner such that the hose liner and material are secured to an outer face of the fitting.

2. The method according to claim 1, further comprising:
flaring the hose liner onto the outer face of the fitting; and
forming a face groove in the hose liner.

3. The method according to claim 1, wherein the fitting provided is configured to conduct heat to the material.

4. The method according to claim 1, wherein the fitting provided includes at least one groove configured to receive at least a portion of the material.

5. The method according to claim 1, wherein the material is a melt-processable material.

6. The method according to claim 5, wherein the material includes at least one of perfluoroalkoxy (PFA) or fluorinated ethylene propylene (FEP).

7. The method according to claim 6, wherein the hose liner drawn through the fitting is formed of a fluoroplastic, including at least one of perfluoroalkoxy (PFA) or fluorinated ethylene propylene (FEP).

8. The method according to claim 1, wherein bonding includes at least melting the material and the hose liner.

9. The method according to claim 8, wherein bonding further includes compressing the material and the hose liner at a predetermined pressure while melting.

10. The method according to claim 9, wherein bonding further includes cooling the material and the hose liner to a predetermined temperature at least below the melting points of the material and the liner.

11. The method according to claim 10, wherein bonding further includes uncompressing the material and the hose liner upon cooling.

12. A hose comprising:
a hose liner;
a retaining member extending from the hose liner;
at least one fitting having an outer sealing face, the fitting configured to receive the hose liner therethrough and configured to engage at least a portion of the retaining member to retain at least a portion of the hose liner against the sealing face of the fitting.

13. The hose according to claim 12, wherein the portion of the hose liner secured to the face of the fitting extends outwardly of the outer sealing face and is a flared portion.

14. The hose according to claim 12, wherein the fitting includes at least one groove formed in the sealing face having an opening in communication with the sealing face, wherein the groove is configured to receive at least a portion of the retaining member.

15. The hose according to claim 14, wherein the groove is formed having a substantially polygonal shape.

16. The hose according to claim 15, wherein the groove is formed having a substantially square or rectangular shape.

17. The hose according to claim 15, wherein the groove is formed having a substantially trapezoidal shape.

18. The hose according to claim 13, wherein the groove is formed having a curved shape.

19. The hose according to claim 18, wherein the groove is formed having a substantially teardrop shape.

20. The hose according to claim 18, wherein the groove is formed having a substantially semicircular shape.

21. A fitting for a hose comprising:
a body portion configured to received a hose liner therethrough; and
a flanged portion extending from the body portion including an outwardly directed sealing flange, the flanged portion configured to receive a hose liner therethrough, wherein the sealing flange is configured to receive a portion of the hose liner and is configured to receive and retain at least a portion of a retaining member when the retaining member is in a melt-processable state and when the retaining member is in a bonded state when bonded to the portion of the hose liner.

22. The fitting according to claim 22, wherein the sealing flange is configured to receive the portion of the retaining member in a bonded state to retain the portion of the hose liner against the sealing flange.

23. The fitting according to claim 21, wherein the portion of the hose liner is a flared portion that is flared over the retaining member.

24. The fitting according to claim 23, wherein the sealing flange includes at least one groove having an opening in communication with a surface of the sealing flange, the groove configured to receive and engage at least a portion of the retaining member.

25. The hose according to claim 24, wherein the groove is formed having a substantially polygonal shape.

26. The fitting according to claim 25, wherein the groove is formed having a substantially square or rectangular shape.

27. The fitting according to claim 25, wherein the groove is formed having a substantially trapezoidal shape.

28. The fitting according to claim 24, wherein the groove is formed having a curved shape.

29. The fitting according to claim 28, wherein the groove is formed having a substantially teardrop shape.

30. The fitting according to claim 28, wherein the groove is formed having a substantially semicircular shape.

31. The fitting according to claim 24, wherein the sealing flange further includes a sealing gasket groove configured to receive a sealing gasket.

32. The fitting according to claim 31, wherein the opening of the groove is positioned at a surface of the sealing gasket groove.

33. The fitting according to claim 32, wherein the sealing flange and sealing gasket groove are configured in accordance with the American Society of Mechanical Engineers Bio-Pharmaceutical Equipment (ASME BPE 2009).

34. The fitting according to claim 33, wherein the body portion and the flanged portion are arranged coaxially with a longitudinal axis.

35. The fitting according to claim 34, wherein the groove extends in a direction at a predetermined angle with respect to the longitudinal axis.

36. The fitting according to claim 35, wherein the angle is an acute angle.

37. The fitting according to claim 36, wherein the angle is less than or equal to 45 degrees.

38. The fitting according to claim 35, wherein the groove is configured to receive a melt-processable material formed as an o-ring.

39. The fitting according to claim 38, wherein the groove is configured to receive an o-ring having a cross sectional diameter between 0.035 and 0.060 inches.

40. The fitting according to claim 21, wherein the retaining member is formed from at least one of perfluoroalkoxy (PFA) or fluorinated ethylene propylene (FEP).

41. The fitting according to claim 21, wherein the sealing flange is configured to conduct heat to the groove.

42. The fitting according to claim 41, wherein the sealing flange is configured to connect to a forming tool.

43. The fitting according to claim 42, wherein the forming tool includes a sealing flange configured to seal against the flared portion of the hose liner, and is configured to conduct heat to the sealing flange of the fitting.

44. The fitting according to claim 43, wherein the forming tool further includes a includes a heat sink extending from the sealing flange configured to conduct heat to the sealing flange of the forming tool.

45. The fitting according to claim 33, wherein the groove is an annular groove.

46. The fitting according to claim 45, wherein the melt-processable material is formed as a ring.

47. A hose produced according to the steps of:
providing a fitting configured to receive a hose liner therethrough and configured to receive a material configured to be bonded to the hose liner;
receiving the material in the fitting;
drawing the hose liner through the fitting; and
bonding the material to the hose liner such that the hose liner and material are secured to an outer face of the fitting.
